(19) United States
(12) Patent Application Publication
(10) Pub. No.: US 2004/0172225 A1
(43) Pub. Date: Sep. 2, 2004

(54) Information processing method and system for synchronization of biomedical data

(75) Inventors: Alan Hochberg, Wilmington, DE (US); Michael Liebman, Paoli, PA (US)

Correspondence Address: FOLEY AND LARDNER, SUITE 500, 3000 K STREET NW, WASHINGTON, DC, 20007, US

(73) Assignee: ProSanos Corp.

(21) Appl. No.: 10/629,848

(22) Filed: Jul. 30, 2003

Related U.S. Application Data
(63) Continuation-in-part of application No. PCT/US02/17015, filed on May 31, 2002.
(60) Provisional application No. 60/294,638, filed on Jun. 1, 2001.

(51) Int. Cl. G06F 17/10

(52) U.S. Cl. 703/2

(57) ABSTRACT

An information processing method and system, for synchronization of disease progression data of individual patients, includes receiving disease progression data in an aperiodic form and representing the disease progression data as a set of functions having finite asymptotic values. The parameters of the set of functions are clustered and the step of representing the disease progression data as a set of functions includes transforming the functions into time invariant form and thereby synchronizing individual patient data that is clustered.

### CROSS REFERENCE TO RELATED APPLICATIONS

The application is a continuation-in-part to PCT Application Serial No. PCT/US02/17015 filed on May 31, 2002, which claims priority to provisional application serial No. 60/294,638 filed on Jun. 1, 2001, the contents of which are incorporated herein in their entireties.

### BACKGROUND OF THE INVENTION

1. Field of the Invention

This invention relates generally to the field of disease stratification and staging which can be used in predictive medicine to assess disease progression. More specifically, the present invention relates to synchronization of biomedical data, such as disease progression data, so that disease progression for individuals can be analyzed more meaningfully.

2. Description of the Related Art

Modern medicine makes use of disease-specific knowledge to: (a) select the best and most cost-effective therapy for an individual patient; and (b) guide the development of: (i) the next generation of diagnostics, (ii) therapeutic drugs, (iii) health-care products, and (iv) lifestyle recommendations. Knowledge about a particular patient is derived from observations of that patient. These observations may include family history, findings from a physical examination, blood and urine test results, imaging studies such as MRI and CT, and the like; genetic information is also being obtained more frequently. In addition, gene-expression and protein-expression data from microarray technology will soon be available for clinical use.

Increasingly, traditional disease classifications are being subdivided into categories according to the mechanism or gene responsible, even though all categories share common clinical features. This subdividing process is known as “disease stratification.” Stratification can be used to select the most appropriate diagnostic and therapeutic course for a patient, and to predict outcomes. It can also be used to define appropriate stratum-specific targets for drug development. Generally, stratification has been based on: (a) a single salient biochemical marker; (b) obvious differences in response to current therapy; or (c) differences in particular genes.

One of the main reasons for obtaining diagnostic information is to determine the stage of progression of a patient's disease. This information is critical to determining the appropriate therapy for the disease. In the case of cancer, the stage of the disease will determine whether surgery, radiation therapy, chemotherapy, or a combination of the above is most appropriate, and will further determine the exact approach to each. In the case of kidney disease, the stage of disease will determine whether the disease is best treated with medicine, diet and lifestyle changes, or whether dialysis and transplantation need to be considered. By way of another example, staging and evaluation of postmenopausal osteoporosis can be used to balance the benefits of hormone replacement therapy against the risks of adverse effects from estrogen use.

At the current state of clinical practice, both stratification and staging involve ambiguity and overlap. Single-disease markers fail to give a complete picture of disease progression. In assessing diabetes, for example, both glucose and Hemoglobin A1c are measured; one gives a short-term measurement while the other assesses long-term glycemic control.

Ambiguities may arise in how to stage a particular patient, depending on which markers of disease progression are used. Moreover, the defined stages of the disease may overlap. Accordingly, better methods are needed to determine (a) the disease path on which a patient is located and (b) where the patient is along that path.

In particular, since “time zero” of a patient's disease progression is rarely known, there is a need for an efficient way to synchronize the relevant biomedical data without requiring excessive computation. Typically, the available data consists of clinical records which describe changes to several quantitative variables over time. An investigator wishes to stratify patients into groups depending on their clinical course. This process is complicated by the fact that the data is generally unsynchronized, i.e., data records begin at varying points in the course of the disease. Therefore, patients whose data do not look alike, in terms of their current clinical picture, in fact may belong to the same disease stratum because they could be at different time points along the continuum of a given pattern of disease progression (or stratum).

### SUMMARY OF THE INVENTION

A solution to one or more of the previously described deficiencies can be achieved by an information processing method and system which can stratify a disease and predict its progression and more accurately synchronize the relevant disease progression data without requiring excessive computation.

An information processing method, system, and software for synchronization of disease progression data of individual patients, includes: receiving disease progression data in an aperiodic form; representing the disease progression data as a set of functions having finite asymptotic values; and clustering parameters of the set of functions. The step of representing the disease progression data as a set of functions includes transforming the functions into time invariant form and thereby synchronizing individual patient data that is clustered.

A better understanding of the information processing method and system assessment of disease progression by synchronization of disease progression data will be easier to appreciate when considering the detailed description in light of the figures described below.

### BRIEF DESCRIPTION OF THE DRAWINGS

The accompanying drawings, which are incorporated in and constitute a part of the specification, illustrate an embodiment of the invention and together with the description, serve to explain the principles of the invention.

FIG. 1, which is a flow diagram of the current treatment protocol for kidney disease, shows how approximately forty distinct diseases lead to end stage renal disease which is then currently treated by dialysis and possibly further by kidney transplant;

FIG. 2(a) is a plot of tumor size versus time for one genotype of a particular type of cancer; FIG. 2(b) is a plot of tumor size versus time for another genotype of the same cancer shown in FIG. 2(a);

FIG. 3(a) is a plot of a first patient's tumor growth versus time; FIG. 3(b) is a plot of a second patient's tumor growth versus time; FIG. 3(c) is a plot of a third patient's tumor growth versus time; FIG. 3(d) is a plot of a fourth patient's tumor growth versus time. The patients in FIGS. 3(a)-3(d) have the same general type of cancer, although they may have different forms of it;

FIG. 4(a) depicts the tumor growth plots for the four patients represented in FIGS. 3(a)-3(d) when plotted over the same time course; FIG. 4(b), which depicts the curves of FIG. 4(a) realigned, shows that two of the patients in FIGS. 3(a)-3(d) likely share one genotype of the disease represented by one stratum of disease progression whereas the other two patients in FIGS. 3(a)-3(d) likely share a different genotype of the disease represented by a different stratum;

FIG. 5 is a flowchart representing the formulation of a model based on the measured time dependent data which is used to determine a particular disease's strata;

FIG. 6 shows a plot of a stratum for Hemoglobin A1C, entitled “HBA1C;”

FIG. 7 shows a plot of a stratum for Retinopathy, entitled “ETDRS”;

FIG. 8 shows a plot of a stratum for Motor Nerve Velocity; and

FIG. 9 shows a plot of a stratum for Sensory Nerve Velocity.

FIG. 10 is diagram illustrating a logistic curve.

FIG. 11 is a flow diagram illustrating the steps of a data synchronization and clustering algorithm in one embodiment of the invention.

### DETAILED DESCRIPTION OF THE EMBODIMENTS

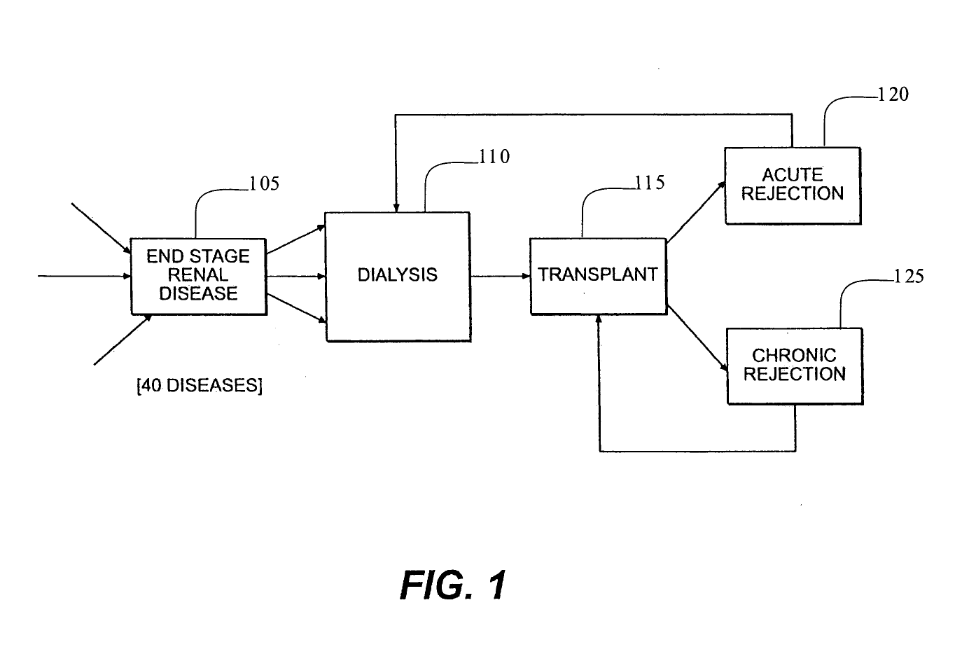

Reference will now be made in detail to embodiments of the invention, which are illustrated in the drawings. In one aspect, the present invention comprehends a model of disease progression that is based entirely on the data provided. The approach of the invention does not require input regarding the underlying theory or mechanisms of the disease. In one aspect, as discussed with respect to FIGS. 1-9, the present invention relates to employing disease progression data as the basis for stratification and staging. In another aspect, in the section entitled “Single-Pass Synchronization of Biomedical Data,” the present invention relates to synchronization of disease progression data (as an example of the more generic category of biomedical data), so that the disease progression data from different sources (or patients) can be meaningfully aligned along the time dimension.

The present invention, in one aspect, employs clinical observations of patients or other organisms as the basis for stratification and staging. The observations are stored and processed in a digital computer system. Some or all of the observations, from some or all of the patients, may be processed at once. Parameters derived from the data are subjected to the statistical procedure known as “cluster analysis,” which groups patients together based on the shape of the curves representing changes in observed variables over time. Each cluster of patients potentially represents a different disease stratum. Adjustments are made to account for the fact that observations of different patients begin at different points in the progression of their respective disease processes. These adjustments can be used to determine the stage of disease progression for each individual patient within their disease stratum. Once the strata and stages are initially defined, the cluster analysis and adjustments can be repeated, so that a convergent, iterative process of stratification and staging takes place. Furthermore, the section entitled “Single-Pass Synchronization of Biomedical Data,” provides a technique for synchronization of data along the time dimension without requiring multiple iterations and this technique may be used to assist the process of stratification and staging as also discussed further herein.

The present invention stratifies diseases based on observations of patients. The term “stratification” refers to the identification of subsets within what has been traditionally known as a single disease, such as breast cancer. A “patient” typically refers to a human individual affected by a disease, but it encompasses animals and even plants that are subject to disease processes. Uses of stratification include: (a) identifying molecules which are targets for the development of therapeutic drugs, aimed at a particular disease stratum; (b) selecting optimum therapy, which may include drugs and/or lifestyle changes, based on a particular stratum; (c) selecting diagnostic tests based on a particular stratum; or (d) predicting the course of disease based on the stratum into which that patient falls.

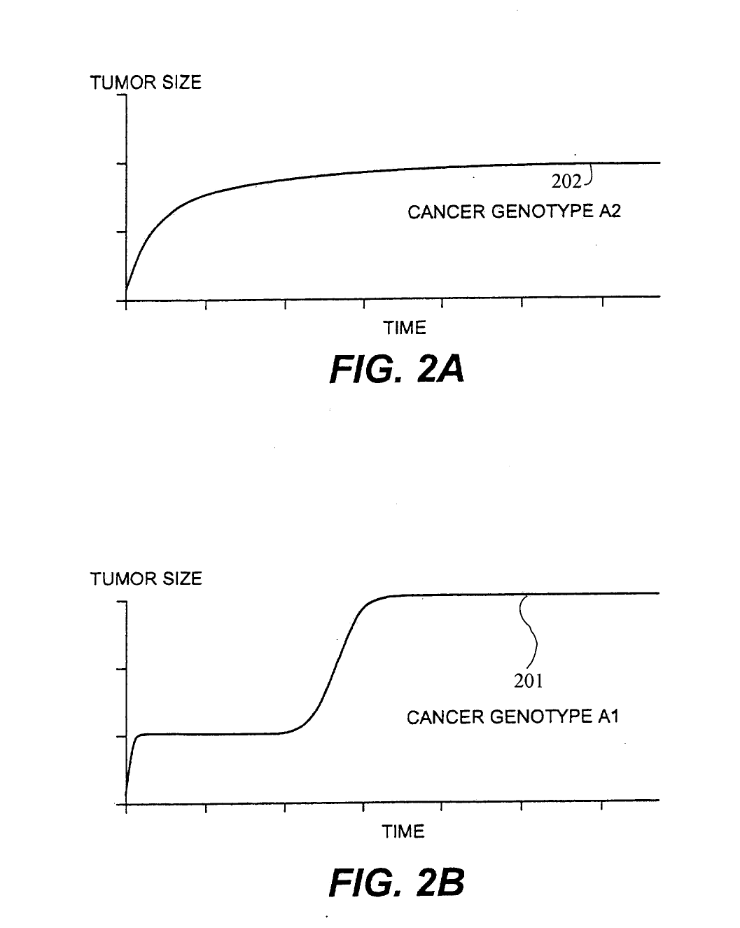

As a hypothetical example, FIGS. 2(a) and 2(b) show plot of a tumor growth over time for two different genotypes of cancer. Tumor size is associated with the severity of the disease. Genotype A1 201 and Genotype A2 202 may clinically appear to be the same disease, but they follow different time courses. By analyzing data from a large number of patients over time, the present invention can assist the clinician and researcher in distinguishing between these two distinct forms of cancer, which may in fact respond to different kinds of treatment. For simplicity, a single disease-associated variable, tumor size, is shown. In an actual application, the distinctions between Genotype A1 201 and Genotype A2 202 might not be apparent unless several additional variables, such as cell DNA content and expression of various genes, are examined in a high-dimensional space.

The present invention also determines the stage of progression of a patient's disease, based on an analysis of observations of the patient. Diseases tend to progress through a series of stages over time, particularly if untreated. Treatment may modify the order of progression, or may alter the amount of time spent in each stage of the disease process. FIG. 1 shows an example of the stages of renal disease leading to kidney failure and transplant. Any one of a large number of medical conditions can bring a patient into a state of end-stage renal disease 105, in which the kidneys are no longer competent to filter waste products from the bloodstream. The patient will then be placed on dialysis 110. A number of dialysis patients will go on to receive kidney transplants 115. Some of these will suffer acute rejection 120 and loss of the kidney due to the immune response. Others will suffer effects from chronic rejection 125, but will eventually be able to maintain some state of health with the transplanted kidney. While FIG. 1 illustrates disease stages as discrete steps, other diseases progress on a continuous basis, and the distinction between stages (e.g., tumors staged as I, II, III, etc.) is not a natural division, but rather a convenience for the clinician and researcher.

It is important that each patient be observed periodically over time. If observations are not made at several points in time, one cannot tell, for instance, if a patient is being seen early in the course of a severe disease, or later in the course of a milder one. The observations of each patient may consist of any of the items that might enter a patient's medical record. Results of a family history and physical examination may be included, along with laboratory test results from blood, urine, or other specimens. Imaging studies such as MRI may be included. Special tests such as electrocardiograms or pulmonary-function tests may be included. Results of histological/pathological examination of specimens may be included as well. Results of genetic testing may be included, and are expected to fulfill an important role in the future. Data from DNA microarrays may be included to measure gene expression in patient tissues of importance. Data from newer microarray technology may measure protein expression as well. The date of observation may be recorded, along with the observation itself. For some patients, observations may cover the entire time course of the disease, including the time period prior to the appearance of the first symptoms.

In all cases, these data should be obtained in or converted into a form that will permit two observations to be compared in a numerical fashion, in order to determine a “distance” between them. For verbal descriptions such as in the physical exam, this can be accomplished with a controlled vocabulary and numerical coding. For example “The patient appears well” could be coded as a “5,” with “The patient appears acutely ill” as a “3,” and “The patient is comatose” as a “1.” For imaging studies, it may be necessary to measure features within the image, such as the diameter of tumors. More subjective features, such as pulmonary infiltrates in a chest X-ray, could, for example, be rated by clinicians on a scale of 0/+ to ++++, coded by the numbers 0 to 4. Presence or absence of genes may be coded as 0 or 1. Multiple possible alleles of a given gene may each be given a particular code. An “observation” refers to a single number, or description that can be converted to a number, associated with a particular patient at a particular time. A “variable” is an aspect of the patient that may be observed, such as blood pressure, tumor diameter, serum creatinine level, or the expression level of a particular gene.

In general, a patient may have more than one disease, and multiple diseases may interact. A given disease may be characterized by one or more observations, or by a measure of disease progression derived from those observations. This includes disease-progression measures derived from the present invention. Such measures may fill the role of “observations” in the investigation of a second disease present in the same patient. Thus, the present invention may be generalized so that it can be used to study more than one disease at a time in a particular patient population.

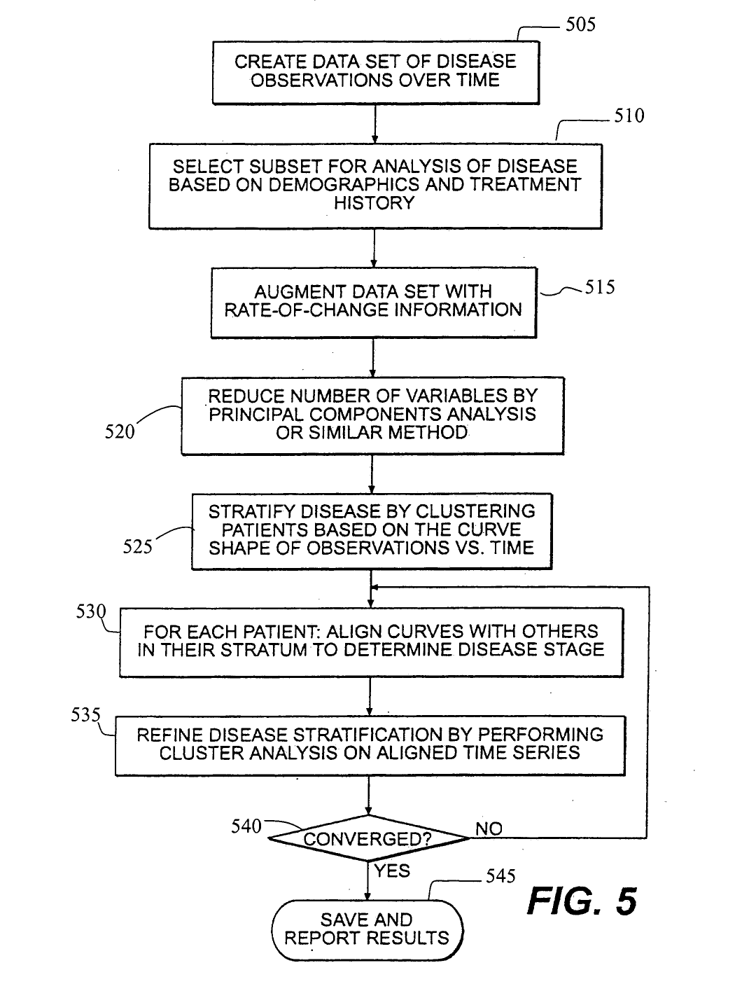

FIG. 5 shows a flowchart of the analysis process. Observations are stored in a digital computer system. The observations may be entered manually via a keyboard, or may be transferred from another computer such as a Laboratory Information Management System (LIMS), electronic medical record, or genetic analysis system. As shown in steps 505 and 510, the data set of disease observations over time is used to select a subject for analysis of disease based on, for example, demographics and treatment history.

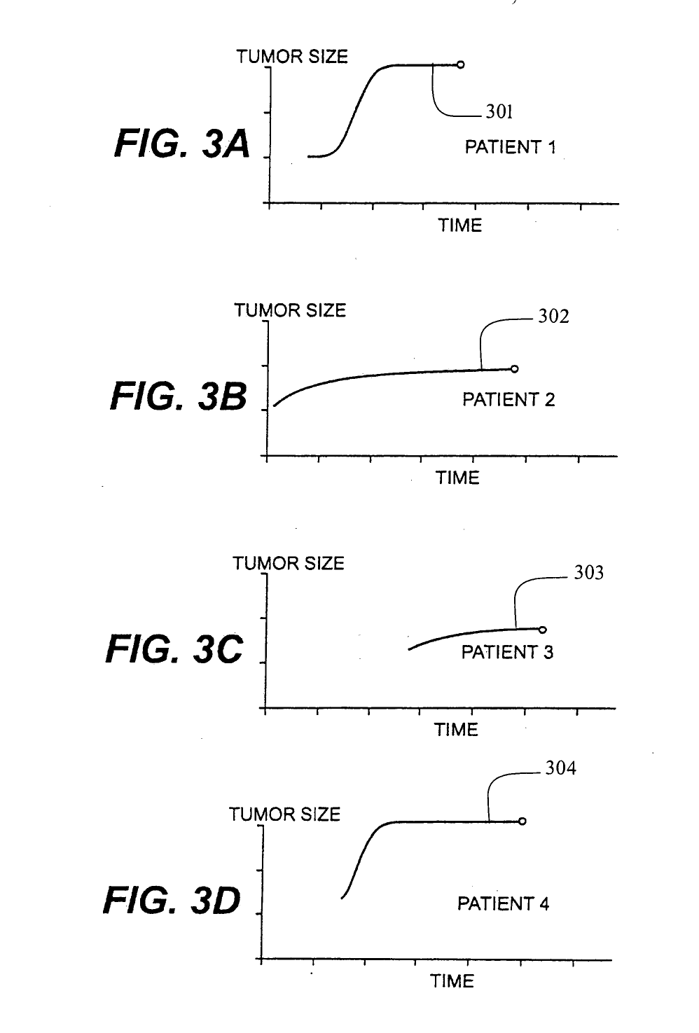

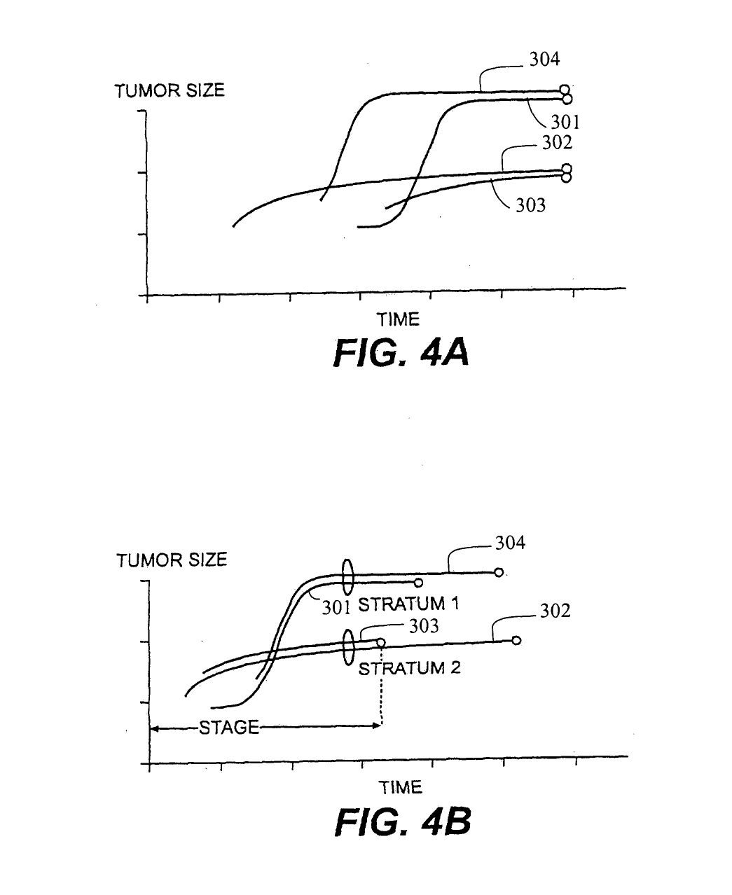

While “staging” of diseases is generally thought of in discrete terms (e.g., “Stage I,” “Stage II,” “Stage III,” etc.), for purposes of this invention, the stage of disease is generally a continuous numerical value. These continuous staging estimates can be derived by shifting the patient time series in step 515 with respect to one another within each stratum so that they are aligned. FIG. 4(a) shows that, if the patient data series 301-304 shown in FIGS. 3(a)-(d) are aligned in “real time,” they cannot be directly compared against one another, because they are not aligned in terms of the stage of the disease process. FIG. 4B shows the patient data series 301-304 aligned in “real-time”.

As shown in steps 520-545, once the time series are aligned, the next goal is to stratify the disease by clustering patients together who have similar time courses. This process begins with the creation of a “distance matrix,” as known to one skilled in statistics, particularly cluster analysis. A triangular matrix of distances among all pairs of patients must be computed. Each inter-patient distance will be a function of individual distances calculated for each variable. The function would take the form of a sum or weighted sum. The distances for a given variable would be, in turn, a sum of distances between individual observations for that variable. This sum also may be weighted.

In conventional clustering, one typically works from a distance matrix, which lists the similarity of every object to be clustered versus every other object. Conventionally, this distance matrix is computed once at the start, and then used during the clustering process. However, time shifts inherent in the data cause the distance matrix to vary dynamically as the clusters are formed. This simply means that part of the distance matrix must be updated whenever a cluster is formed.

Distances between observations may be measured in several ways. In cluster analysis, absolute differences or squared differences are often used for numerical variables. In some cases, such as numerically-encoded gene alleles, it may be desirable to manually create a lookup table to evaluate the “distance” between any two possible observations.

For the stratification and staging process to be effective, it may be necessary to restrict the population of patients for which the analysis is carried out. For example, it would not be meaningful to compare certain variables observed in babies with the same variables in adults, even if they share the same disease. Also, it will be necessary to ensure that a single analysis does not include a mix of patients who have been subjected to widely varying therapeutic interventions. Otherwise, the method will likely create false “strata” consisting of treated patients in one stratum, and untreated patients in another. Thus, in one embodiment of the invention includes a step of specifying criteria in terms of patient demographics (age, height, weight, sex, etc.) and treatment history. Only those patients who meet the specified criteria will be included in subsequent analysis. The criteria used to select patients will differ from one disease to another.

For purposes of subsequent cluster analysis, it will generally be desirable to include the rate of change of variables with respect to time. There are many published algorithms for calculating the derivatives of a time series. Some of these incorporate multi-point filtering so as not to unduly amplify noise in the data. These algorithms, such as Savitsky-Golay filters, may be useful in connection with some embodiments of the present invention.

For each patient, a time series, including data points for what may be a relatively large number of variables, is present in the data set. In such circumstances, it is generally found that a number of variables are highly correlated with one another. Thus, there may be “extra” variables that carry little significant information. Neural networks and statistical techniques, such as principal components analysis and factor analysis, may be used to reduce the number of variables carried forward into the calculation. Parenthetically, these techniques can have the added advantage that they give insight into the relationships among the variables being studied, and can reduce the number of variables needed for future studies.

The iterative process of disease stratification 530-540 and staging begins by clustering the patients. Each patient has a number of time-dependent measurements associated with him or her which define a time progression (also called a time series). Each time progression describes a curve corresponding to the observed variable measurements over time. The initial clustering is based on the shape of these curves. Clustering must be based on curve shape rather than on a direct distance measure between the curves, because observations for each patient begin at a different point in time along the course of that patient's disease process (i.e., the calendar date of the observation gives no indication as to how far a patient's disease has progressed). Except in special cases, such as accidental laboratory infection, one does not generally know when “time zero” is. As the computer analyzes the entire time course of a disease, it distinguishes between a patient who is in the early stages of a severe disease from a patient who is in the later stages of a milder one (since the curve shapes will generally be different in the two cases).

Clustering of curve shapes can be accomplished by any of several time progression alignment algorithms. Any conventional clustering algorithm may be used to do the stratification. There are many such algorithms, such as “Single Linkage,” “Complete Linkage,” “K” means, “Ward's Method,” or the “Centroid Method.” These algorithms would be well-known to anyone familiar with the data analysis art, and are available in standard statistical packages such as SAS and SPSS. These algorithms group like objects together, and keep unlike objects in separate groups. As an initial step, a Savitsky-Golay filter or similar formula can be used to calculate time derivatives for the values forming the curve, thereby eliminating the effect of any constant offset from one curve to another, while also emphasizing curvature and other shape-defining features. The curves can then be aligned with respect to one another by an algorithm such as dynamic programming or wavelet transforms. Each cluster may represent a stratum of disease. It may be desirable for a human operator to split or merge clusters, after examining the data in detail, to obtain the most clinically-meaningful disease stratification.

We start with each patient in a separate stratum, then let the clustering algorithm agglomerate these strata. The strata are time-shifted with respect to one another when combined, to account for the fact that a patient is almost never observed a “time zero” of the disease process. Further, each patient (or stratum) has a first observation at a different point in the disease process. The appropriate amount of time shift can be determined either iteratively (a range of possible shift amounts is applied and the one that gives the best fit to a mathematical model is chosen) or analytically (least-squares equations are solved, based on the models themselves, to find the best time-shift).

When combining strata, we next find a “consensus” time shift that gives an acceptable fit for all of the disease variables measured. Finally, the combined strata are fit to an overall mathematical model which is subsequently re-tested to ensure an acceptable fit. Without re-testing the model, it is conceivable that the model would represent a long “daisy chain” of patients, strung together in time, in a way that would not represent any plausible disease process.

Within each stratum, the time series for each patient may be further aligned in time to reduce the mean inter-patient distances. The amount of shift required to bring the time series into alignment can be used directly to update the estimate of the patient's current disease stage. This is equivalent to estimating the calendar date of “time zero” for that patient. The cluster analysis can then be repeated. This iterative process will generally converge. At the end, the clusters will represent disease strata, and the amounts of shifting applied to each patient's data, along with the observations as the final time point, indicate the stage of progression of each patient's disease. FIG. 4(b) shows the result of this analysis process. The data are aligned by disease stage, and can therefore be clustered into strata representing subsets of the disease under study. The distance from the time origin to the open circle is a measure of the disease stage, or progression, for each patient.

In summary, the synchronization and stratification uses a three-step process of clustering, where, to combine a pair of strata one: (1) determines a best time-shift for each variable; (2) determines a consensus time-shift for all variables together; (3) fits the combined, shifted data to a model; and (4) accepts the combined stratum as valid if the fit is acceptable upon re-testing the model.

An approach to assist in the synchronization of patient time course events may include those described in Prestrelski et al., Proteins 14: 430-39, 440-50 (1992). Prestrelski sets forth a method which enables the alignment and synchronization of discretely measured features and permit determination and compensation for gaps in the measurement variable, using dynamic programming methods.

In the examples of the Prestrelski articles, the time domain at varying points, which may or may not be coordinated in sampling or synchronization, was not sampled. Rather, the equivalent domain was defined as the position, within an amino acid sequence, which could be similarly numbered in a manner which may be non-identical. The position was chosen as the domain because of the presence of gaps or insertions within the linear axis or at the beginning of the axis coordinate.

An example of the application to stratification and clustering in disease analysis can be seen in the application to the examination of a database of heart transplant recipients and donors. In such a study, there is a great deal of information concerning the recipient both pre- and post-transplant, and minimal information concerning the donor pre-transplant and none post-transplant. A desired outcome of such analysis would be to determine the potential for enhancing the criteria used to match donors and recipients to enable greater success in the transplant procedure, i.e., survival of the recipient with a transplanted heart. The standard of care requires tissue typing and matching. Additional algorithms, based on the potential matching of donors with recipients of lesser body mass, have been implemented with the expectation that the heart (which is comprised of muscle) would be more likely to survive any atrophy occurring during the transplant and more successful in a smaller recipient. Analysis of this data would normally focus on predicting survival versus non-survival which could be represented by a 1 and 0, respectively.

Application of the dynamic programming analysis described in the Prestrelski et al. articles enables the donor weight to recipient weight factor to be further refined to incorporate the fact that recipients are typically physically compromised at time of transplant and their actual weight will be below their ideal weight, which more closely reflects the desired organ functional profile. In addition, the donor may, by virtue of being overweight or in poor physical shape, be significantly higher than their ideal weight; dependence on the simple actual weight ratios may not incorporate the “quality” of the donated material adequately. Further, analysis of the survival/non-survival state indicated that this simple classifier was inadequate to represent: (a) the actual desired outcome (which was length of survival); and (b) the potential ability of standard of care procedures to evaluate this adequately post-transplant. Conversion of the scoring of the patients to reflect length of time with successful transplant survival: (a) enabled the progression of transplant success or failure to be more accurately determined; (b) enabled the identification of several specific clusters of progression (in time) which could be related to causative factors that could be anticipated and corrected prior to the procedure; and (c) evaluated the potential utility of the standard of care post-transplant. Accordingly, laboratory tests were successful in warning of potential risks for organ failure or rejection.

FIGS. 3(a)-(d) show the time course of tumor growth 301-304 for four patients (continuing the hypothetical cancer example set forth in FIGS. 2(a) and 2(b)). The graphed lines in each figure begin with the first measurement taken on the patient corresponding to each of those figures. In general, patients will seek medical care at different points in the progression of their cancer, when symptoms first appear. Thus, no data are available to cover the pre-symptomatic period, even though the tumor exists and is growing during that time. The open circle represents the date of the latest (most current) measurement for each patient.

Stratification and staging data can then be used for the development of diagnostics, therapeutics, and lifestyle guidelines, and can be used to predict disease outcome and optimize therapy for a particular patient. Once the full analysis has been performed on an adequate set of patients, it is much simpler to stratify and stage disease for a new additional patient. The new patient's observations can be simply aligned and clustered for a best fit to the existing data set. In addition, new observations based on new technologies or methodologies such as clinical, biological, genetic, etc. can be incorporated into the stratification process at any time. The alignment will indicate the disease stage previously described, and the cluster assignment will indicate the stratum to which the patient belongs. Moreover, the model can be updated to reflect the new patient; in this fashion the accuracy of the model can be continuously improved over time.

To elucidate the conceptual description of embodiments of the invention, an explanation of the method by which the foregoing is accomplished will now be set forth by describing, in detail, a process for stratification and synchronization of patient data to form a disease model.

Preliminarily, inputs for the model must be defined. The input to the disease modeling process is a set of observations over time, made on a set of N patients, designated i=1 . . . N. There are M different clinical variables which are observed, and these are designated j=1 . . . M. Each variable is observed for each patient at a time designated by t. The number of observations, which may vary among the N patients, for each patient are indexed by k=1 . . . nᵢ. In general, the values of t may differ from patient to patient, and from variable to variable. Thus, the observations consists of an ordered set of pairs {tᵢⱼₖ, yᵢⱼₖ}, i=1 . . . N, j=1 . . . M, k=1 . . . nᵢ. where for each time t (and for each patient N), there is a corresponding measurement y for each variable M.

A first output of the disease modeling process is designed and intended to partition the patient population into strata, or clusters. Each stratum represents a pattern in the way that a prototypical “model patient” can progress through a disease. In other words, members of a given stratum share a similar pattern in the way that their observed disease variables evolve over time.

Depending on the particular clustering algorithm used, a given patient may appear to fall into more than one stratum. For example, this can happen if the patient is only observed early in the course of their disease, and there is not enough information to fully determine to which stratum the patient belongs. It could also happen if the observations occur late in the disease process, and it cannot determined by which path the patient got there.

A second output of the disease modeling process is a set of model functions for each variable and for each stratum. These model functions describe the pattern by which each variable can be expected to evolve over time for a patient who is a member of the given stratum. A third output of the disease-modeling process is a set of time-offset values, one for each instance where a patient is a member of a stratum. The time offset values are determined such that they shift the data for the given patient in time to give the best fit (in a least-squares sense) of the patient's observed data to the corresponding model functions for the stratum. Note that there is one time-offset value per patient, not one per variable. All of the variables for a given patient are inherently linked in time by their co-occurrence in an actual patient and, therefore, are not shifted in time with respect to one another.

To achieve the desired outputs, an understanding of the stratification and synchronization process is necessary. The synchronization process causes patient records to be offset from one another in time as they are joined together to form strata. A stratum formed by the joining of patients in this fashion is designated by a triple (A, B, Δ), which means “the record for patient B is appended to the record for patient A with an offset of Δ between the first observation time for A and the first observation time for B. The sign of Δ is positive if B's first observation occurs later than A's and negative if B's first observation occurs before A's. “Strata” then recursively play the role of “patients” in the joining process. For example, a finalized stratum might be designated this way:

(((A,B,−10.3),(C,D,−6.1),+3.2),E,+1.7)

If (A,B,−10.3) is assigned “Q,” and (C,D,−6.1) is assigned “W,” the result becomes:

((Q,W,+3.2),E,+1.7).

Further, if (Q,W,+3.2) is assigned “Z,” the finalized stratum becomes:

(Z,E,+1.7)

To begin the modeling process, each patient is placed into its own stratum. That is, patient A becomes a stratum: (A, null, 0). The patient data may be pre-conditioned before the modeling algorithm is applied. The variables should be transformed if necessary (log, square root, etc.) to stabilize variance, so that equal differences in y have equal clinical significance. Variables that are oscillatory or periodic should be replaced by variables that will fit the smoother models used here (e.g., an envelope or amplitude function, or some indication of the number of oscillatory cycles or their frequency). Noise in the data may be removed by digital filtering prior to the stratification process itself.

At each step of the process below, data for the variables within each stratum are fit to mathematical model functions. The mathematical formulation of the model functions should be chosen so that the model curves exhibit the same general shape features as the actual data. The formulations should also be chosen to have clinically-appropriate behavior when extrapolated beyond the time interval over which the actual data is fit. Thus, mathematically simple forms, such as quadratic and cubic models, may be undesirable, because they diverge to ± outside of the region where they are initially fit. A linear model has been successfully employed, because the error introduced by extrapolation is acceptable.

Within the guidelines above, other model formulations can be used besides the ones described here. In the modeling process, for example, four different mathematical formulations for models are used in succession:

Constant: y(t)=α

Linear: y(t)=α+βt

$$\text{Logistic:} y ( t ) = a + ( b - a ) \frac{{ⅇ}^{α + β t}}{1 + {ⅇ}^{α + β t}} or ln ( - \frac{y ( t ) - a}{y ( t ) - b} ) = α + β t$$

$$\text{Quadratic Logistic:} y ( t ) = a + ( b - a ) \frac{{ⅇ}^{α + β t + γ {t}^{2}}}{1 + {ⅇ}^{α + β t + γ {t}^{2}}} or ln ( - \frac{y ( t ) - a}{y ( t ) - b} ) = α + β t + γ {t}^{2}$$

For a given stratum, each variable ultimately fits into one of these four types of models. Fitting takes place by the following process: First, the data is “fit to a constant” by least squares. This is equivalent to simply setting α equal to the mean value of the data. The root-mean-square (RMS) deviation of the data from the model is then determined.

Second, the data is fit to a linear model, and the RMS deviation from the best-fit straight line is determined. If the RMS deviation decreases by more than a specified fraction (a parameter of the modeling process), then the linear model is accepted. Otherwise, the constant model is used.

Third, the data is fit to a logistic curve by an iterative least-squares fitting procedure. The least-squares fitting, in one embodiment, employs a Java routine developed by Steven Verrill of the U.S. Forestry Service, and is adapted from a corresponding FORTRAN software package described in R. B. Schnabel, J. E. Koontz, and B. E. Weiss, A Modular System of Algorithms for Unconstrained Minimization, Report CU-CS-240-82, Comp. Sci. Dept., University of Colorado at Boulder, 1982. The linear model is used to establish initial values for the least-squares iteration. Again the RMS deviation of the data from the curve is determined, and if the fit improves sufficiently versus the linear model, the logistic model is accepted.

Fourthly, and finally, this procedure of fitting, followed by acceptance of the new model if the fit improves sufficiently, is repeated for the quadratic logistic curve. At the end of this step, for each stratum, i.e., for each of the variables, there is a description of the type of model (i.e., constant, linear, logistic, or quadratic-logistic) and the number of parameters for the model. Constant models have one parameter, linear models have two, logistic models, four, and quadratic-logistic models, five.

The next step examines all pairs of strata. Note that pairs are “ordered pairs,” i.e., (A, B) is not equivalent to (B, A). When combining strata, no patient can appear more than once in the combination. Any pairs in which a given patient appears in both stratum A and stratum B are ignored. For each pair of strata, each variable is considered in turn. The first step, for each variable, is to determine the best values (over a suitable range) for Δ, such that the data for stratum B fits (in a least-squares sense) the model for stratum A when offset in time by Δ. In the present example, this is done by simply iterating the least-squares calculation at a series of equally-spaced candidate values for Δ; an alternative would be to generate a set of normal equations and solve for the best value of Δ directly. Note that several values of Δ may give nearly the same degree of fit. In fact, if the model for patient A is constant, all values for Δ give an equivalently good fit within some range ε, which is a parameter of the modeling process. Thus, at this step in the process, Δ may be a list of values or a range, rather than a single value.

The algorithm rejects the pair of strata if the best Δ gives a fit to B's data which does not have a small enough RMS deviation from the curve of A's model. The threshold for RMS deviation is another parameter of the modeling process which one of ordinary skill in the art of statistics can set at an appropriate value depending on the nature of the analysis. If this occurs for any variable, then A and B are not considered candidates for inclusion into the same stratum during the current stage of the process. If, however, the stratum pair (A, B) yields an acceptable Δ (or set of Δ's) for all variables, then the next step is to try to reconcile these values into a single Δ for all variables. There can be only one Δ which relates stratum A and stratum B. It is not physically realistic for there to be a separate Δ for each variable, since these data stem from real observations of a real patient at a particular single point in time.

In this example, the process is to count the number of variables which are consistent with each of the values of Δ listed for the stratum pair. This results in a reduced list of Δ's which are common to all of the variables. If the reduced list contains more than one possible value for Δ, in this example the Δ with the smallest absolute value is chosen. Other options for resolving such ties, such as picking the Δ which gives the best overall RMS fit, may be considered.

At this point, strata A and B are merged into a new stratum, designated (A, B, Δ), i.e., the data for A and B are combined, using an offset of Δ for B's data with respect to A's. A new stratum for the combined stratum is then determined using the four model types as described above. The new stratum is “accepted” if the final RMS model fit for the combined data set is sufficiently good, as determined by comparing it against a value which is a parameter of the fitting process. If the stratum is accepted, the stratum (A, B, Δ) is added to the set of strata for evaluation.

The steps of evaluating pairs are repeated until all possible pairs have been evaluated. At that time, the list of accepted strata may be edited to remove strata below a certain size, and/or those which have not merged with another stratum during a certain number of passes. Editing may be done by some other method which permits the accumulation of large strata while reducing the time spent repetitively evaluating small strata which are “outliers” and are unlikely to merge. The pair-evaluation process is then repeated for a subsequent pass, until no new strata are formed.

As an alternative to the merging of pairs described above, an alternative clustering algorithm may be used, such as the “leader algorithm” described in J. W. Hartigan, CLUSTERING ALGORITHMS (John Wiley & Sons, 1975), at pages 74-83. In addition, in a clinical or pharmaceutical research context, membership and position in the various strata can be correlated with clinical and genomic data.

### EXAMPLE #1

Data for modeling were taken from public files for the Diabetes Control and Complications Trial, which are available via ftp on the Internet at gcrc.umn.edu/pub/dcct/. Records for 730 patients in the Standard treatment group were used, since the patients in the Experimental treatment group were artificially “synchronized” by the intervention of the trial. For each patient, ten annual measurements were extracted for four variables (i.e., I=1 . . . 730, j=1 . . . 4, k=1 . . . 10): (a) Hemoglobin A1C (a measure of blood-glucose control); (b) Retinopathy (ETDRS scale scores from fundus photographs, the fundus being the part of an eyeball); (c) Motor Nerve Velocity; and (d) Sensory Nerve Velocity. The latter two values are measures of peripheral neuropathy, another complication of diabetes. Missing values were filled from the most recent previous available value.

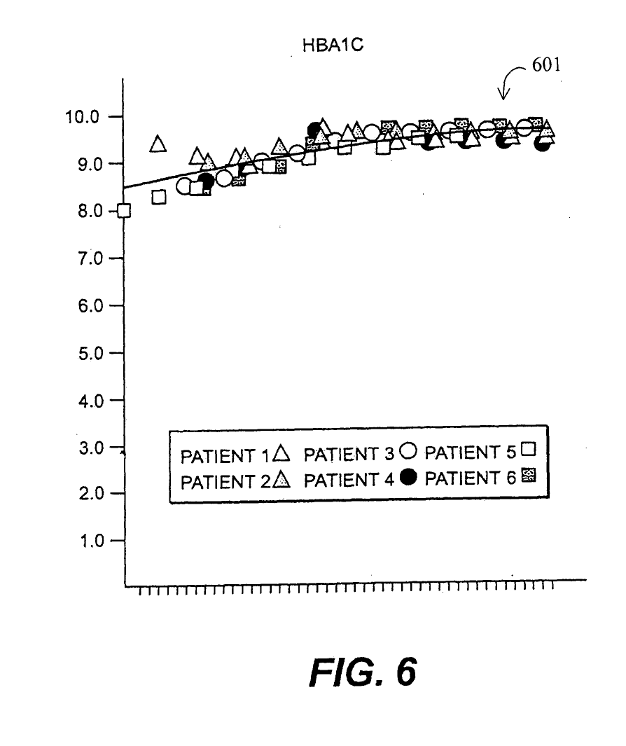

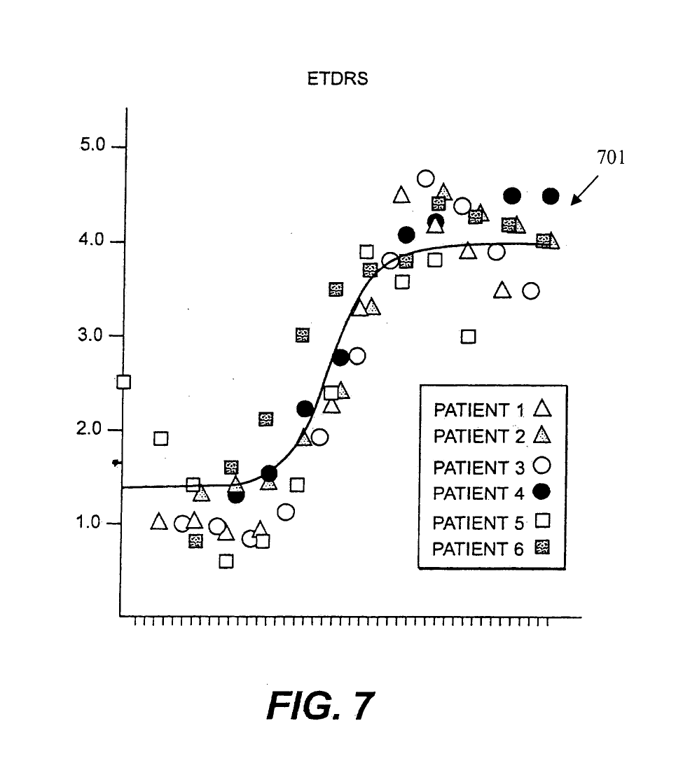

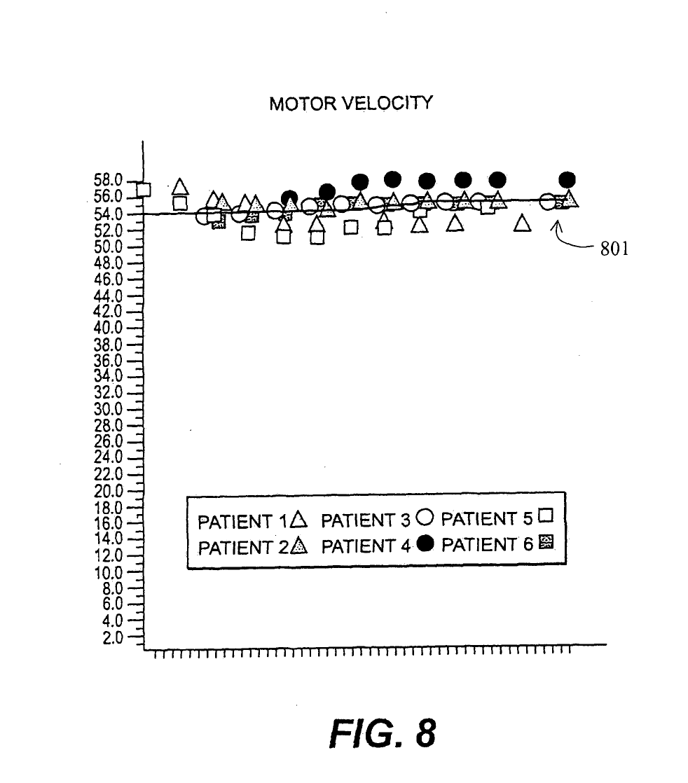

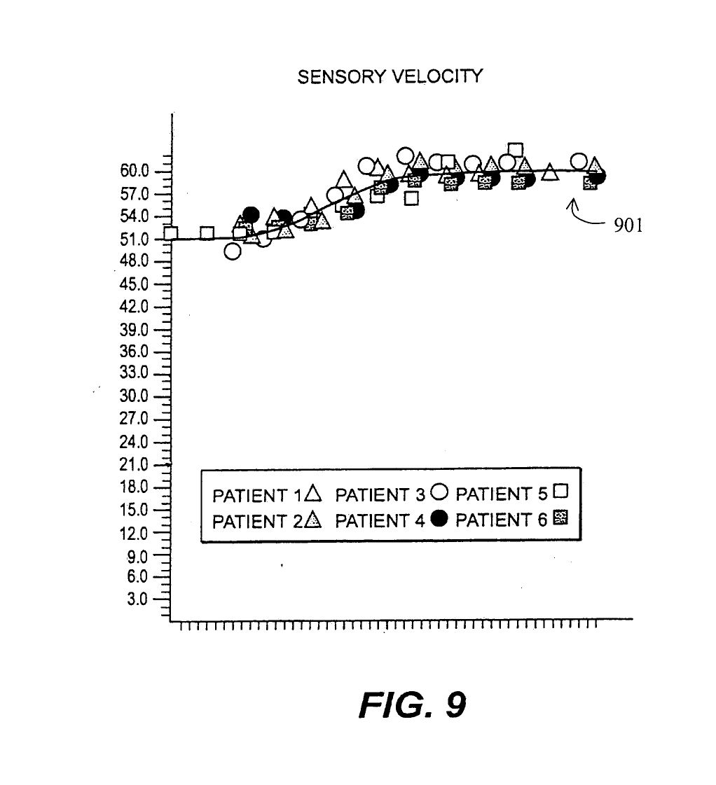

The algorithm previously described was used to cluster the patients into strata by employing time shifts to align like shaped curves. Results for the four observed variables strata are shown in FIGS. 6-9 in which: (a) FIG. 6 shows a stratum 601 for Hemoglobin A1C, entitled “HBA1C;” (b) FIG. 7 shows a stratum 701 for Retinopathy, entitled “ETDRS;” (c) FIG. 8 shows a stratum 801 for Motor Nerve Velocity; and (d) FIG. 9 shows a stratum 901 for Sensory Nerve Velocity. FIGS. 5-9 indicate how the patient records may be fit together by using an appropriate time shift. Thus, each stratum describes a picture of how a prototypical patient would progress through their disease with regard to the four variables studied. The markers in the figures indicate actual patient data points; the lines in each of FIGS. 6-9 are the best-fit modeling function for the strata.

Single-Pass Synchronization of Biomedical Data

Biomedical data, such as disease progression data, may be synchronized without requiring iterations in the synchronization process. Therefore, the synchronization process can be computed more efficiently and by using standard software packagesfor calculations and clustering.

In one aspect, the synchronization technique disclosed herein synchronizes disease progression data (as an example of biomedical data that may synchronized using the techniques disclosed herein). The available data typically consists of clinical records which describe the changes in several quantitative variables over time. Typically, the data covers an insufficient duration to describe the entire course of a patient's disease. Therefore, an investigator that wishes to stratify the patients into groups encounters additional complications based on the fact that the disease progression data of the various patients are not synchronized along the time dimension (i.e., with respect to a hypothetical time zero). Therefore, patients' data that do not look alike may actually belong to the same disease stratum because they may represent data from different time points along the continuum of a given pattern of disease progression.

The data synchronization technique disclosed here solves at least three problems in the stratification and synchronization of disease progression data as listed below.

(1) By fitting the data to logistic curves or other similar forms, the possibility of periodic data is eliminated. One skilled in the art would recognize that it is not possible to synchronize periodic data per se since the problem would be inherently ambiguous. A similar situation arises in bioinformatics, in that it is not possible to unambiguously align repetitive DNA sequences. In some cases, periodic data can be transformed into an aperiodic form. For example, if a disease is characterized by periodic episodes, one could utilize the cumulative count of episodes, over time, as an aperiodic variable in the present method.

(2) When only short segments of data (i.e., over a short duration) are available for some patients, they may appear to be linear or constant data segments. Fitting this type of data to a logistic or similar curve is an ill conditioned problem. Accordingly, the present data synchronization technique handles such data segments appropriately by using constant or linear models for them.

(3) The technique provides a translation invariant description of a patient's data, so that synchronization takes place automatically in addition to facilitating the stratification process. In other iterative techniques, the complexity of the synchronization process grows exponentially as the complexity of the data set grows.

In one aspect, the data synchronization technique of the present invention involves representing clinical data as a set of functions having finite asymptotic values. For example, in one embodiment, the clinical data may be represented as a set of logistic curves. Logistic curves can be applied to modeling disease progression data, since they transition from an initial constant value, at a specified rate until they reach a final constant value. They are unidirectional, so that they do not fit all types of data although they fit many clinical variables very well. They have appropriate asymptotic behavior and are not periodic. In should be understood that other mathematical models may be used in the present invention as long as they have finite asymptotic values and are preferably aperiodic. A quadratic-logistic or other type of model can be used accommodate data increases to a peak or plateau value and then declines. In such a case, a curve representing a clinical variable may have several linear or constant segments. The technique disclosed herein may be adapted to deal with them as discussed further herein.

If all the data could be fit to a logistic curve, stratification and synchronization would be straightforward. However, much of the data in a typical data set may consist of short segments which lack statistically significant curvature. These data segments may appear to be either linear, or constant over time. Attempting to fit these data segments to a logistic curve would pose an ill-conditioned mathematical problem. The strategy for dealing with these quasi-linear or quasi-constant data records is provided further herein.

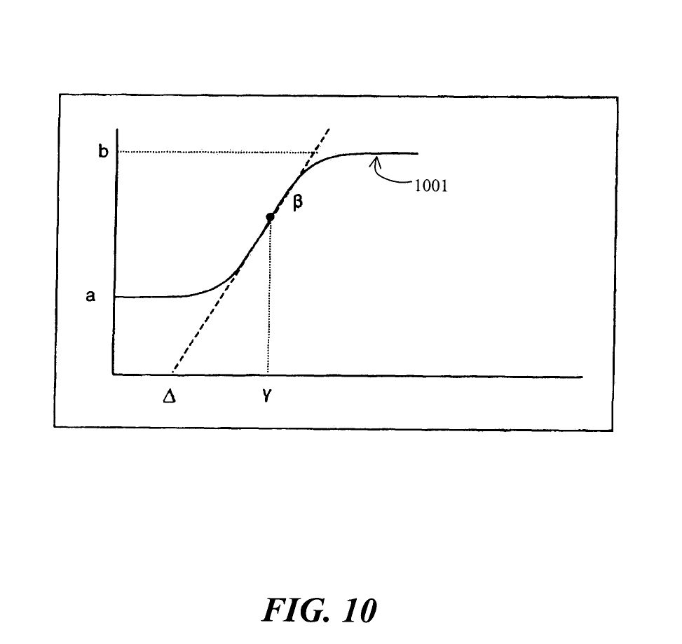

FIG. 10 illustrates a typical logistic curve 1001 that may be used for the data synchronization technique provided by the present invention. The logistic curve 1001 may be represented by an equation of the form:

$$Λ ( a , b , β , γ ) = a + ( b - a ) \frac{{ⅇ}^{β ( t - γ )}}{1 + {ⅇ}^{β ( t - γ )}}$$

It should be noted that that Δ, the x-intercept of the linear portion of the logistic curve 1001, is not a parameter of the logistic function, but is an auxiliary variable that will be used by the data synchronization technique provided by one aspect of the present invention. Formulas for calculating Δ from the curve parameters are discussed further herein. In the formula above, a and b represent the y intercepts of the logistic curve 1001, γ represents the location of the inflection point of the logistic curve 1001, and β represents the slope of the logistic curve at the inflection point.

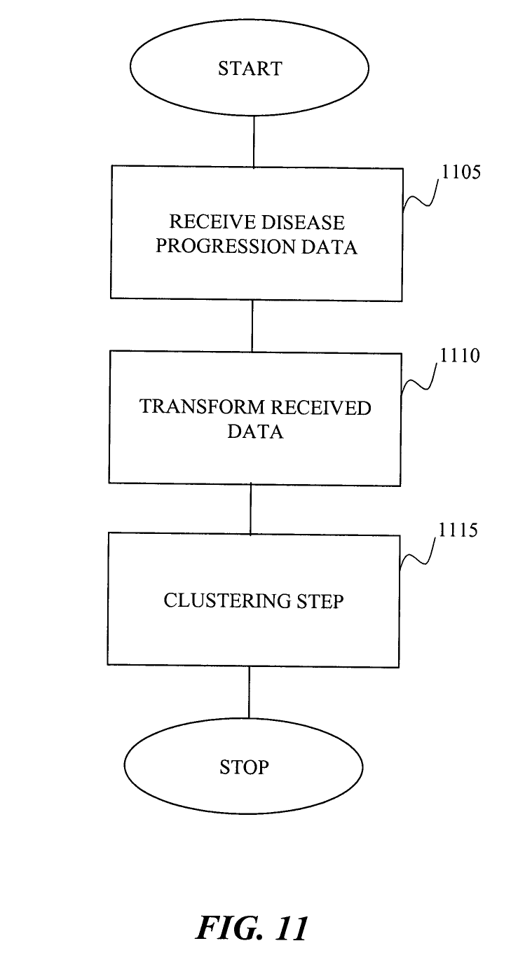

As shown in flow chart of FIG. 11, clinical data that is received in step 1105, typically cannot be used directly for stratification. Because each patient record samples only a portion of the underlying logistic function, data from the same underlying logistic function may appear very different, depending on what portion of the curve is being sampled. Instead, in step 1110, the data synchronization technique proposed by one aspect of the present invention clusters the parameters of the logistic curves (the a's, b's, β's, and γ's) in a transformed version. The transformation accomplishes two things: it renders the representation of the data into a translation-invariant form, so that “synchronization” occurs automatically along with stratification; and it handles the case of linear or constant data, where a fit to a logistic curve would be mathematically ill-conditioned.

Thereafter, in step 1115, the data synchronization method utilizes a clustering algorithm to partition N patients into groups based on data about V variables for each of the N patients. Depending on the clustering algorithm, the number of groups may be pre-specified (e.g., K-means clustering algorithm) or may be determined by the algorithm from specified parameters (e.g., using the complete linkage technique). For each patient i and variable j, there is, therefore, a set of data points

{tᵢⱼₗ,dᵢⱼₗ},l=1 . . . nᵢⱼ

Ignoring, for the moment, the possibility of linear or constant data for the moment, each variable will be fit, for each patient, to a logistic model

$${m}_{ijl} = Λ ( {a}_{ij} , {b}_{ij} , {β}_{ij ,} {γ}_{ij} ) = {a}_{ij} + ( {b}_{ij} - {a}_{ij} ) \frac{{ⅇ}^{{β}_{ij} ( {t}_{ijl} - {γ}_{ij} )}}{1 + {ⅇ}^{{β}_{ij} ( {t}_{ijl} - {γ}_{ij} )}}$$

This fitting (in the clustering step 1115) can be performed by nonlinear least squares, for example, by using a local Taylor series expansion for the logistic function. A Jacobian matrix can be computed, allowing the calculation of an error covariance matrix for the fit of the function to the data. Depending on the clustering algorithm used, this covariance matrix may be supplied as input to the distance function used in the clustering algorithm.

Standard Euclidean distance functions can be used as the distance function. But if an estimate of the variance for each variable is available, an appropriate distance measure might be based on the z-score (as defined below).

So for two variables with estimates θₐ and θ_{b} and associated variances σₐ² and σ_{b}² the distance (z score) can be computed from the following formula:

$${z}^{2} = \frac{{( {θ}_{a} - {θ}_{b} )}^{2}}{{σ}_{a}^{2} + {σ}_{b}^{2}}$$

In one embodiment, an enormous computational advantage in this step can be realized by pre-clustering the patient data into “base patterns,” which represent highly-similar data records for individual variables. The fitting of each “base pattern” to determine logistic parameters, corresponding to the base pattern, needs to be performed only once. Thereafter, the patients can simply be “pointed to” these sets of parameters for “their” base patterns.

In step 1110, by changing the parameterization of the data for each patient, the clustering algorithm in step 1115 can solve the synchronization problem automatically, in addition to performing stratification. To accomplish this, each patient's individual curves (corresponding to the variables) are represented by using their a's, b's, (the y intercepts) but the β's and γ's ( which represent the slope and the location of the inflection point of the logistic curve) are transformed. These parameters (the β's and γ's) tie the curves to the time axis, and the transformation based on these parameters results in a translation-invariant form. In particular, the γ's (the inflection points) are modified, based on the slope of the linear portion of the curve, to give a value for Δ (the x-intercept of the linear portion of the logistic curve) that is used to transform the curves into the translation invariant form. For example, the curves may be transformed so that all the curves are transformed to have a common value for Δ. Alternatively, the value of Δ used to synchronize the curves on the time duration may be fixed to be within a certain range of values.

Therefore, if the slope m of a logistic curve is given by

$${m}_{ij} = \frac{{β}_{ij} ( {b}_{ij} - {a}_{ij} )}{4}$$

$$then$$

$${Δ}_{ij} = {γ}_{ij} - \frac{{a}_{ij} + {b}_{ij}}{2 {m}_{ij}}$$

And to create the translation-invariant formulation

Δ′_{ijjj*}=Δᵢⱼ−Δ_{ij*}

for each pair of variables j and j*. The remainder of the method uses a, b, m, and the transformed Δ's, to represent each curve.

In the above discussion, Δ is defined as the X-intercept, that is, the point where the curve crosses (or where the extrapolated curve would cross) the line y=0. To improve the accuracy of synchronization, it may be desirable to define Δ as an intercept with a fixed value y=Y other than zero. This may prevent small errors in m from being magnified in the calculation of Δ.

If a more complicated model is used, for example, by using a quadratic-logistic curve instead of the logistic curve, one skilled in the art of statistics would recognize that there will be additional parameters although the same transformation principles discussed above will still apply. These additional parameters may represent, for example, the value of quasi-constant curve segments, the slope of quasi-linear segments, and the x-intercepts of those quasi-linear segments.

If the distance measure to be used for clustering is one that makes use of a covariance matrix, such as the z-score distance described earlier herein, the covariance matrix for the Δ's can be derived by propagation-of-error formulas. For example, a first-order Taylor series expansion of the formulas discussed earlier herein can be generated. This Taylor series will then express the covariance of the Δ's in terms of the variables whose covariance is already known from the curve-fitting procedures.

As would be recognized based on the above discussion, synchronization would be simplified if one could establish a “master variable” (present in the data for each individual patient) that would never be constant, and could be counted on to provide a landmark to synchronize patients and clusters in time. The synchronization discussion herein assumes that no such variable exists. Lacking such a master variable, a symmetric approach is used, where all variables are treated equally, and a triangular matrix of Δ' differences is stored. This renders the representation of each patient's data in a translation-invariant form. Therefore, when the patients are clustered, they are automatically “synchronized” as well.

After the clustering process, the time origin can be restored for the data corresponding to each patient. In one embodiment, this can be accomplished by averaging each of the Δ′'s for a given cluster, then adjusting a given patients Δ's by an amount δ which gives the best fit to the group average. In other words, let

\overline{Δ}′ₖⱼ=mean_{lεclusterk}(Δₗⱼ)

then

δᵢ=meanⱼ(\overline{Δ}′ₖⱼ−Δᵢⱼ)where iεcluster k

From these formulae, δᵢ is the shift to apply to patient i to align it to the cluster.

In one embodiment of the synchronization and clustering algorithm, output and input of the algorithms can be represented as follows. A feature vector Xᵢ, representing a patient i with V variables per patient, consists of

$$3 V + \frac{V ( V - 1 )}{2}$$

elements:

[aᵢₗbᵢₗmᵢₗaᵢ₂bᵢ₂mᵢ₂ . . . Δ′ᵢₗ₂Δ′ᵢₗ₃ . . . Δ′ᵢ₂₃ . . . ]

Appropriate covariance information may be retained and used in the calculation of inter-patient differences. This information can be fed into a clustering algorithm to produce a number G of patient clusters, representing G different disease progression strata or patterns.

With K-means-type clustering algorithms, the pre-set number of clusters G must be determined. This is often done by trial and error, or by one of several methods described in the literature on K-means as is known to those skilled in the art of statistics.

Note that if the pre-clustering step above indicates that it is possible to cluster patients, not just individual variables, then it may be possible to represent each cluster only once in the clustering algorithm, and thereby substantially increase computation speed.

In one embodiment of the method of synchronization and clustering according to the present invention, non-curvilinear data needs to be handled as discussed next herein. To handle the non curvilinear data, when the data is modeled, the model is characterized as either CONSTANT, LINEAR, or LOGISTIC. Additional types such as QUADRATIC-LOGISTIC, may be also accommodated based on the same general principles.

To determine the appropriate type of model, the data is first fit to a CONSTANT model, rᵢⱼₗ=sᵢⱼ, where sᵢⱼ=meanₗ(dᵢⱼₗ). The method then determines the root-mean-square

$${e}_{c ; ij} = \sqrt{\frac{{\sum }_{l} {( {d}_{ijl} - {r}_{ij} )}^{2}}{{n}_{ij}}}$$

error

Thereafter, the data is fit to a LINEAR model, rᵢⱼₗ=mᵢⱼtᵢⱼₗ+sᵢⱼ, by the formulas of linear regression that are familiar to those skilled in the art of statistics. Linear regression is available and described, for example, in the τm( ) function of the commercially available R Programming Language which has several commercially available implementations. The method then determines the root-mean-square error

$${e}_{l ; ij} = \sqrt{\frac{{\sum }_{l} {( {d}_{ijl} - {r}_{ij} )}^{2}}{{n}_{ij}}} . If \frac{{e}_{l ; ij}}{{e}_{c ; ij}} < η ,$$

then the LINEAR model is accepted over the CONSTANT model, where η is a parameter of the fitting process.

Finally, the data are fit to the LOGISTIC model

$${r}_{ijl} = Λ ( {a}_{ij} , {b}_{ij} , {β}_{ij} , {γ}_{ij} ) = {a}_{ij} + {b}_{ij} \frac{{ⅇ}^{{β}_{ij} ( {t}_{ijl} - {γ}_{ij} )}}{1 + {ⅇ}^{{β}_{ij} ( {t}_{ijl} - {γ}_{ij} )}} ,$$

as discussed above. If the algorithm fails to converge, the LOGISTIC model is rejected. Otherwise, the method again determines the root-mean-square error

$${e}_{g ; ij} = \sqrt{\frac{{\sum }_{l} {( {d}_{ijl} - {r}_{ij} )}^{2}}{{n}_{ij}}} . If \frac{{e}_{g ; ij}}{{e}_{l ; ij}} < η ,$$

then the LOGISTIC model is accepted over the LINEAR model.

Exemplary variables used to describe these partial LINEAR and CONSTANT models are discussed next.

Exemplary Variables to Describe LINEAR Models

Given a linear equation rᵢⱼ=mᵢⱼt+sᵢⱼ which fits data over the range [t₁, t₂], the x-intercept is computed:

$${Δ}_{i j} = - \frac{{s}_{i j}}{{m}_{i j}}$$

The value of mᵢⱼ is stored, along with all the Δ′'s based on Δᵢⱼ. Covariance information derived from the linear regression can he optionally stored, if the distance measure used by the clustering algorithm requires this. The values of aᵢⱼ and bᵢⱼ are recorded as “MISSING”. The clustering algorithm that is used must be one that is tolerant of such missing data.

Variables to Describe CONSTANT Models

For CONSTANT models, there are three possible cases (refer to FIG. 10):

1) The constant data represents a segment from the “a” end of a logistic curve.

2) The constant data represents a segment from the “b” end of a logistic curve.

3) The constant data represents a segment from the middle of a logistic curve, where (a-b) is small.

4) The constant data represents a segment from the middle of a logistic curve where a and b are large, but β is small.

The strategy below handles all cases correctly situation (4) above which is assumed to be rare. To handle constant data, the provided method sets

aᵢⱼ=bᵢⱼ−sᵢⱼ

The mᵢⱼ are all set to “MISSING”, and all Δ′ values which depend on Δᵢⱼ are set to “MISSING”.

The distance-determining rule for the clustering algorithm needs to be slightly modified to account for the fact that s could represent either a or b. Letting dist represent the function of a and b for two patients i and i* that is normally used to compute a component of the distance measure between the two patients. To accommodate constant data, a modified distance rule dist’ must be used:

$${dist}^{ ′} ( {a}_{i j} , {a}_{{i}^{*} j} , {b}_{i j} , {b}_{{i}^{*} j} ) = \{ \begin{matrix}dist ( {a}_{ij} , {a}_{{i}^{*} j} ) + dist ( {b}_{ij} , {b}_{{i}^{*} j} ) {a}_{i j} \neq {b}_{i j} Λ {a}_{{i}^{*} j} \neq {b}_{{i}^{*} j} \\ min ( dist ( {a}_{ij} , {a}_{{i}^{*} j} ) , dist ( {b}_{i j} , {b}_{{i}^{*} j} ) ) otherwise\end{matrix}$$

Using these heuristics, LINEAR and CONSTANT data can be fed into a clustering algorithm, in such a way that their information and their indeterminacy are both properly handled, so that clusters can be generated which contain all of the appropriate patients.

It should be noted that describing the invention with drawings should not be construed as imposing on the invention any limitations that may be present in the drawings. The present invention contemplates methods, systems and program products on any computer readable media for accomplishing its operations. The embodiments of the present invention may be implemented using an existing computer processor, or by a special purpose computer processor incorporated for this or another purpose.

As noted above, embodiments within the scope of the present invention include program products on computer-readable media and carriers for carrying or having computer-executable instructions or data structures stored thereon. Such computer-readable media can be any available media which can be accessed by a general purpose or special purpose computer. By way of example, such computer-readable media can comprise RAM, ROM, EPROM, EEPROM, CD-ROM or other optical disk storage, magnetic disk storage or other magnetic storage devices, or any other medium which can be used to carry or store desired program code in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such a connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

The invention has been described in the general context of method steps which may be implemented in one embodiment by a program product including computer-executable instructions, such as program modules, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

The present invention is suitable for being operated in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices

The invention is not restricted by the description of any of the embodiments previously set forth. Rather, the foregoing description is for exemplary purposes only and is not intended to be limiting. Accordingly, alternatives which would be obvious to one of ordinary skill in the art upon reading the description, are hereby within the scope of this invention. It will be apparent to those skilled in the art that various modifications and variations can be made to the disclosed preferred embodiments of the present invention without departing from the scope or spirit of the invention. Accordingly, it should be understood that the description of the method is for illustrative purposes only and is not limiting upon the scope of the invention, which is indicated by the following claims.

What is claimed is:

1. An information processing method for synchronization of disease progression data of individual patients, comprising:
receiving disease progression data in an aperiodic form;
representing the disease progression data as a set of functions having finite asymptotic values; and
clustering parameters of the set of functions,
wherein the step of representing the disease progression data as a set of functions comprises transforming the functions into time invariant form and thereby synchronizing individual patient data that is clustered.

2. The information processing method according to claim 1, wherein the set of functions having finite asymptotic values comprises a set of logistic curves, and wherein the step of representing the disease progression data as a set of functions comprises fitting each variable for each patient to one of the set of logistic curves.

3. The information processing method according to claim 2, wherein the clustering step comprises using a nonlinear least squares technique.

4. The information processing method according to claim 3, wherein the nonlinear least squares technique comprises:
using a local Taylor's series expansion for a logistic function representative of a logistic curve;
computing a jacobian matrix to calculate an error covariance matrix for the fit of the function to the data; and
using the error covariance matrix as input to provide weighting for a distance function for use in a clustering algorithm.

5. The information processing method according to claim 1, wherein the clustering step includes using a statistical error in determining the function parameters as a weighting for use in a distance function.

6. The information processing method according to claim 1, wherein the step of transforming the functions into time invariant form comprises determining an unambiguous time point based on the shape of a function curve.

7. The information processing method according to claim 6, wherein the unambiguous time point comprises one of a x-intercept or inflection point of the function curve.

8. The information processing method according to claim 7, wherein the set of functions comprise logistic functions, and
wherein the step of transforming parameters of the set of logistic functions into time invariant form for disease progression data of a patient comprises:
determining an x-intercept of a linear portion of the logistic function curve for each variable; and
determining pair wise differences of x-intercepts for all the variables with respect to corresponding x-intercepts of base patterns, and using the determined pair wise differences information in the clustering step to cluster and synchronize the disease progression data of the patient to one of the base patterns.

9. The information processing method according to claim 1, wherein the step of receiving the disease progression data comprises filtering out periodic or cyclical data or transforming the periodic or cyclical data into aperiodic form.

10. A computer program product that causes, when executed, a computing system to synchronize disease progression data of individual patients by performing the steps comprising:
receiving disease progression data in an aperiodic form;
representing the disease progression data as a set of functions having finite asymptotic values; and
clustering parameters of the set of functions,
wherein the step of representing the disease progression data as a set of functions comprises transforming the functions into time invariant form and thereby synchronizing individual patient data that is clustered.

11. The computer program product according to claim 10, wherein the set of functions having finite asymptotic values comprises a set of logistic curves, and wherein the step of representing the disease progression data as a set of functions comprises fitting each variable for each patient to one of the set of logistic curves.

12. The computer program product according to claim 11, wherein the clustering step comprises using a nonlinear least squares technique.

13. The computer program product according to claim 10, wherein the step of transforming the functions into time invariant form comprises determining an unambiguous time point based on the shape of the function curve.

14. The computer program product according to claim 13, wherein the unambiguous time point comprises one of a x-intercept or inflection point of the function curve.

15. The computer program product according to claim 13, wherein the set of functions comprise a set of logistic functions and
wherein the step of transforming parameters of the set of logistic functions into time invariant form for disease progression data of a patient comprises:
determining an x-intercept of a linear portion of the logistic function curve for each variable; and
determining pair wise differences of x-intercepts for all the variables with respect to corresponding x-intercepts of base patterns, and using the determined pair wise differences information in the clustering step to cluster and synchronize the disease progression data of the patient to one of the base patterns.

16. The computer program product according to claim 10, wherein the step of receiving disease progression data comprises filtering out periodic or cyclical data or transforming the periodic or cyclical form into aperiodic form.

17. A system for synchronization of disease progression data of individual patients, comprising:
an input unit for receiving disease progression data in an aperiodic form; and
a computing unit configured to
represent the disease progression data as a set of functions having finite asymptotic values,
cluster parameters of the set of functions,
wherein the step of representing the disease progression data as a set of functions comprises transforming the functions into time invariant form and thereby synchronizing individual patient data that is clustered.

18. The system according to claim 17, wherein transforming the functions into time invariant form comprises determining any unambiguous time point based on the shape of a function curve.

19. The system according to claim 18, wherein the unambiguous time point comprises one of a x-intercept or inflection point of the function curve.

20. A system for synchronization of disease progression data of individual patients, comprising:
means for receiving disease progression data in an aperiodic form; and
means for representing the disease progression data as a set of functions having finite asymptotic values, and
means for clustering parameters of the set of functions,
wherein the step of representing the disease progression data as a set of functions comprises transforming the functions into time invariant form and thereby synchronizing individual patient data that is clustered.
